(19) United States
(12) Patent Application Publication
(10) Pub. No.: US 2017/0270545 A1
(43) Pub. Date: Sep. 21, 2017

(54) CONTEXT-SPECIFIC FORECASTING DEVICE

(71) Applicant: Wal-Mart Stores, Inc., Bentonville, AR (US)

(72) Inventors: Willie Montgomery, III, Rogers, AR (US); Venkataraja Nellore, Bentonville, AR (US)

(21) Appl. No.: 15/462,910

(22) Filed: Mar. 20, 2017

Related U.S. Application Data
(60) Provisional application No. 62/311,392, filed on Mar. 21, 2016.

(51) Int. Cl. G06Q 30/02

(52) U.S. Cl. CPC G06Q 30/0202

(57) ABSTRACT

Examples of the disclosure provide a context-specific forecasting device including a consumption analytics module and a data control module. The consumption analytics module receives a data request for a consumption unit, including an attempted data request value associated with an individual environment and corresponding to a given period of time. The consumption analytics module identifies a forecasted consumption value for the consumption unit corresponding to the individual environment and the given period of time. The consumption analytics module determines a threshold factor for the consumption unit corresponding to the individual environment and the given period of time, and generates an allowance threshold for the data request. The data control module then determines whether to adjust the data request based on the generated allowance threshold and the attempted data request value.

### BACKGROUND

Many environments consume resources, such as supplies, as part of operational costs. In some cases, these resources are indirectly tied to revenue produced by operations of the environment because they enable the environment to perform functions or provide services that generate that revenue. An environment that has inadequate resources may not realize their full potential for revenue, productivity, and other operational metrics.

Some environments may rely on physical resources for optimal operation, which require storage capabilities, such as inventory space at a physical location. Storage capabilities may impact the quantity of these resources that can be present at a physical location at any given time. Ordering too much of any one resource may occupy unnecessary space leading to inefficiencies, or impact a budget allocation. Ordering too little of any one resource may lead to an environment running out of that resource, which could impact operational performance and other services.

### SUMMARY

Examples of the disclosure provide a system and method for context-specific forecasting. Data related to consumption units and saleable units associated with an individual environment is obtained via a communication network. An adjusted unit value of an individual consumption unit is computed for a given time period associated with one or more of the saleable units of the individual environment. The computed adjusted unit value is indexed to generate a consumption unit value for the consumption unit related to at least one of the one or more saleable units. A forecasted consumption value of the consumption unit is generated for the individual environment based on the generated consumption unit value and a composite consumption value associated with a region corresponding to the individual environment.

Aspects of the disclosure provide a context-specific forecasting device including a consumption analytics module and a data control module. The consumption analytics module receives a data request for a consumption unit, including an attempted data request value, the data request associated with an individual environment and corresponding to a given period of time. The consumption analytics module identifies a forecasted consumption value for the consumption unit, the forecasted consumption value corresponding to the individual environment and the given period of time. The consumption analytics module determines a threshold factor for the consumption unit, the threshold factor corresponding to the individual environment and the given period of time, and generates an allowance threshold for the data request. The data control module then determines whether to adjust the data request based on the generated allowance threshold and the attempted data request value.

Aspects of the disclosure provide a forecasting and processing environment that receives a data request for a consumption unit via an interface, the data request including an attempted data request value, associated with an individual environment and corresponding to a given period of time. A forecast component identifies a forecasted consumption value for the consumption unit, the forecasted consumption value corresponding to the individual environment and the given period of time. A data control component identifies a threshold factor for the consumption unit, the threshold factor corresponding to the individual environment and the given period of time, and generates an allowance threshold for the data request

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a computing device for context-specific forecasting.

FIG. 2 is an exemplary block diagram illustrating a forecasting and processing environment for context-specific forecasting.

FIG. 3 is an exemplary diagram illustrating network communication with a forecasting and processing environment for context-specific forecasts.

FIG. 4 is an exemplary flow chart illustrating operation of the computing device to generate a forecasted consumption value for a consumption unit.

FIG. 5 is an exemplary flow chart illustrating operation of the computing device to control a data request process for a consumption unit.

FIGS. 6A & 6B are exemplary diagrams illustrating an interface for interacting with the forecasting and processing environment.

FIG. 7 is an exemplary table illustrating context-specific forecasts and thresholds.

FIG. 8 is an exemplary table illustrating context-specific forecasts and regulations.

FIG. 9 is an exemplary block diagram illustrating an operating environment for a computing device implementing developer environment.

Corresponding reference characters indicate corresponding parts throughout the drawings.

### DETAILED DESCRIPTION

Referring to the figures, examples of the disclosure enable context-specific forecasting for resources, such as consumption resources, associated with an environment. As used herein, an environment may refer to a business environment, such as a retail business for example, and examples are provided that may describe a retail business environment. However, aspects of the disclosure are not limited to a retail or business environment. Supply chain forecasting or sales forecasting generally focuses on supply and demand for a specific product. Aspects of the disclosure provide for context-specific forecasting for an individual environment and consumption unit. Because the forecasting is for a consumption unit, which may have a variable value relative to a product or group of products, and because the forecasting is specific to an individual environment, a context-specific forecast of the consumption unit value for that individual environment may be generated, which may differ from a supply and demand-based forecast or a forecast for another individual environment. As used herein, an individual environment may refer to a specific, physical location, such as a physical store location, with each individual environment representing a separate, physical store location within a possible chain of stores, for example.

Aspects of the disclosure further enable increased user interaction performance and user efficiency via user interface interaction because thresholds and regulation factors in combination with the context-specific forecasts are used to drive a data request based on user interface interaction. Automatic alerts and notification are generated to guide a user towards allowable data request input values, which also contributes to reduced error rate in data request submissions. Additionally, the context-specific forecasts are based in part on individual environment budgets, which mitigate data request issues related to budget incompatibility, provide increased processing speeds for data requests, and reduce processor load.

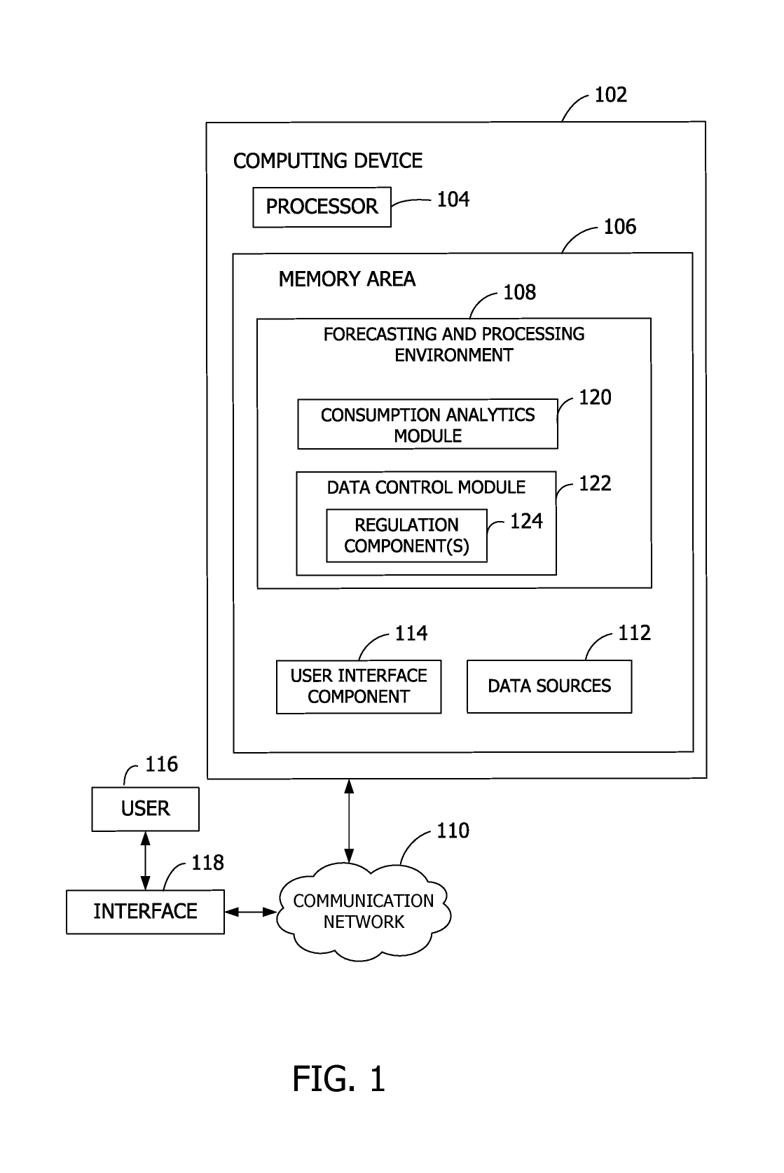

Referring again to FIG. 1, an exemplary block diagram illustrates a computing device for context-specific forecasting and data request processing. In the example of FIG. 1, the computing device 102 represents a system for context-specific forecasting and data request processing for consumption units. As used herein, consumption units refer to products or resources that may be directly tied to the operations of a business yet may be indirectly tied to the business success or revenue of the business. For example, consumption units may include, without limitation, containers, such as plastic bags used to contain goods or products sold by the business but provided at little to no cost to the consumer of the goods or products; paper, such as receipt paper rolls used to catalogue or itemize a purchase of goods or products sold by the business and provided as a record to the consumer of the goods or products; waste paper, such as paper towels provided in a restroom accessible by the customers of the business; food packaging, such as bread sleeves for example, and any other suitable consumption product used in the course of operations to further the operations and services of an environment. In some examples, a data request may refer to an order request or attempted order for a consumption unit.

The computing device represents any device executing instructions (e.g., as application programs, operating system functionality, or both) to implement the operations and functionality as described herein. The computing device may include a mobile computing device or any other portable device. In some examples, the mobile computing device includes a mobile telephone, laptop, tablet, computing pad, netbook, gaming device, and/or portable media player. The computing device may also include less portable devices such as desktop personal computers, kiosks, tabletop devices, industrial control devices, wireless charging stations, and electric automobile charging stations. Additionally, the computing device may represent a group of processing units or other computing devices.

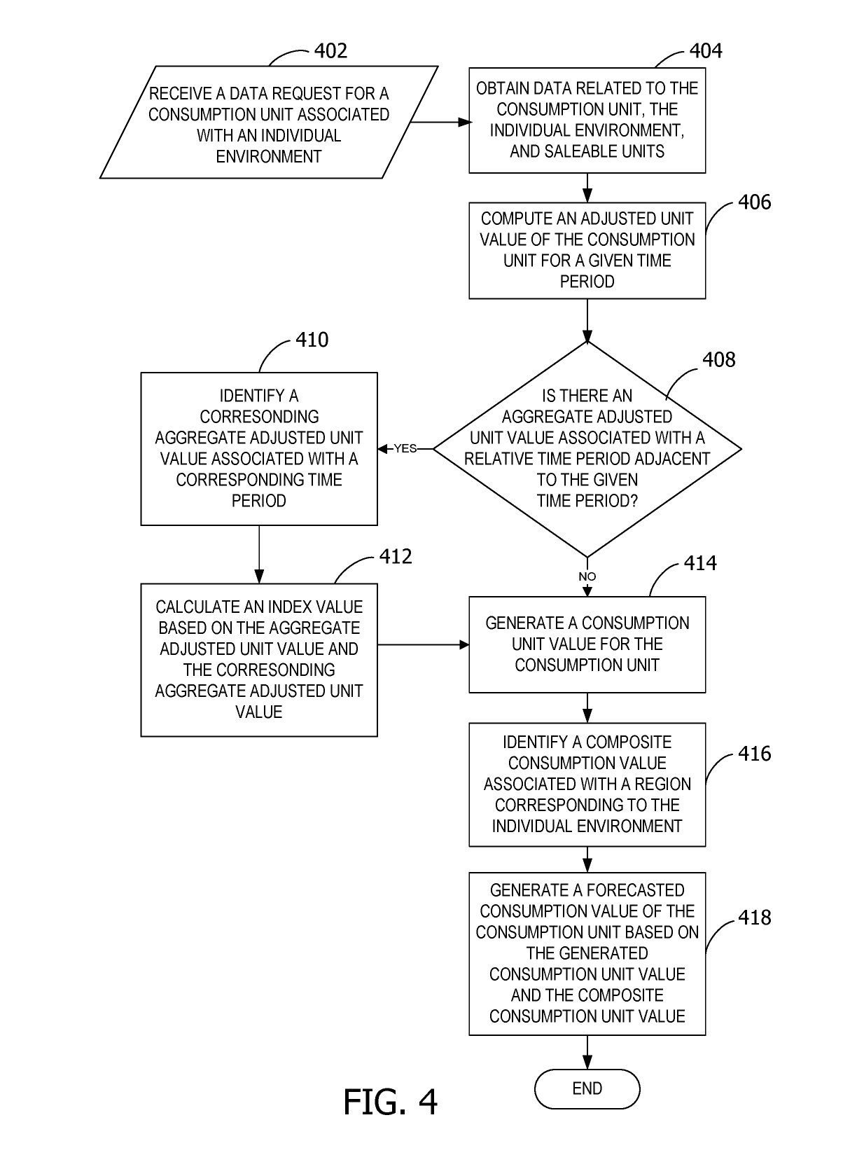

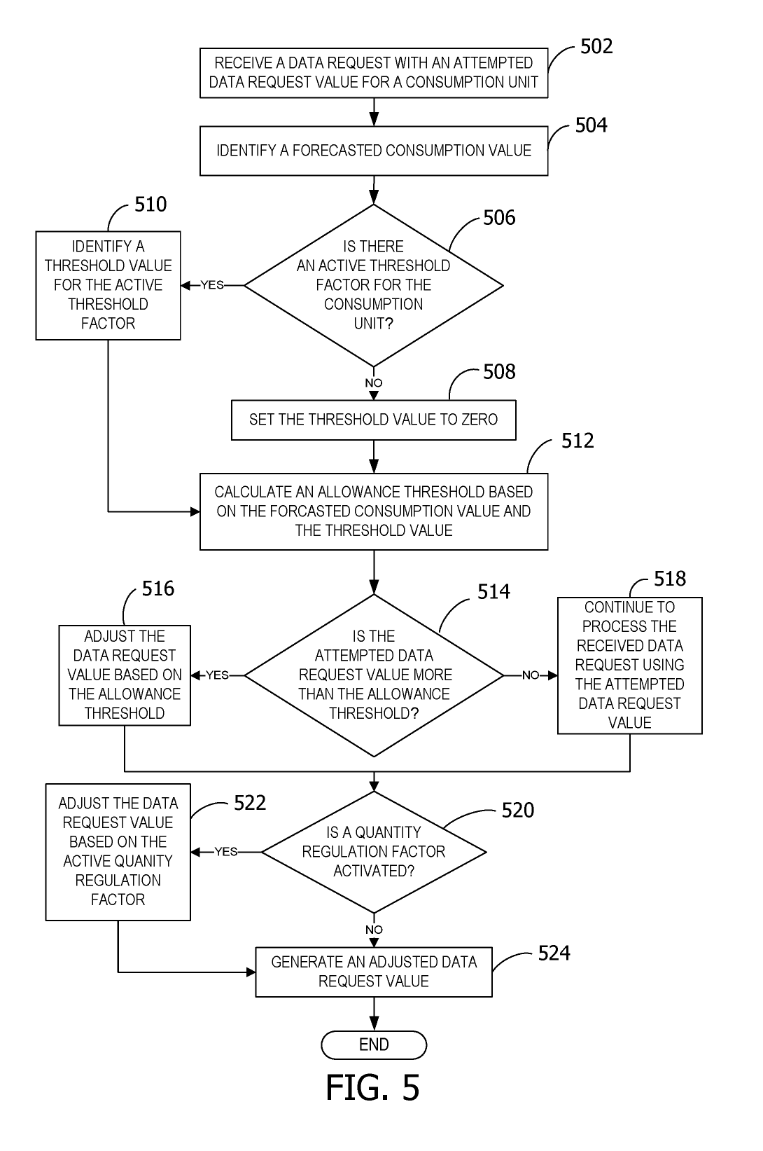

In some examples, the computing device has at least one processor 104, a memory area 106, and at least one user interface. The processor includes any quantity of processing units, and is programmed to execute computer-executable instructions for implementing aspects of the disclosure. The instructions may be performed by the processor or by multiple processors within the computing device, or performed by a processor external to the computing device. In some examples, the processor is programmed to execute instructions such as those illustrated in the figures (e.g., FIG. 4 and FIG. 5).

In some examples, the processor represents an implementation of analog techniques to perform the operations described herein. For example, the operations may be performed by an analog computing device and/or a digital computing device.

The computing device further has one or more computer readable media such as the memory area. The memory area includes any quantity of media associated with or accessible by the computing device. The memory area may be internal to the computing device (as shown in FIG. 1), external to the computing device (not shown), or both (not shown). In some examples, the memory area includes read-only memory and/or memory wired into an analog computing device.

The memory area stores, among other data, one or more applications. The applications, when executed by the processor, operate to perform functionality on the computing device. Exemplary applications include forecasting and processing environment 108, which may represent an application for context-specific forecasting and processing of data requests for consumption units. The applications may communicate with counterpart applications or services such as web services accessible via communication network 110. For example, the applications may represent downloaded client-side applications that correspond to server-side services executing in a cloud. The memory area may store data sources 112, which may represent data stored locally at memory 106, data access points stored locally at memory area 106 and associated with data stored remote from computing device 102, or any combination of local and remote data.

The memory area further stores one or more computer-executable components. Exemplary components include a user interface component. The user interface component 114, when executed by the processor 104 of computing device 102, cause the processor 104 to perform operations, including to receive user selections during user interaction with forecasting and processing environment 108, for example.

In some examples, the user interface component includes a graphics card for displaying data to the user and receiving data from the user. The user interface component may also include computer-executable instructions (e.g., a driver) for operating the graphics card. Further, the user interface component may include a display (e.g., a touch screen display or natural user interface) and/or computer-executable instructions (e.g., a driver) for operating the display. The user interface component may also include one or more of the following to provide data to the user or receive data from the user: speakers, a sound card, a camera, a microphone, a vibration motor, one or more accelerometers, a BLUETOOTH brand communication module, global positioning system (GPS) hardware, and a photoreceptive light sensor. For example, the user may input commands or manipulate data by moving the computing device in a particular way. In another example, the user may input commands or manipulate data by providing a gesture detectable by the user interface component, such as a touch or tap of a touch screen display or natural user interface.

In some examples, a user 116 may interact with the system of computing device 102 via communications network 110 using interface 118. Interface 118 may be a user interface component of another computing device communicatively coupled to communication network 110, for example. In some examples, interface 118 may provide an instance of forecasting and processing environment 108 for receiving user input and displaying content to the user, while forecasting and processing operations are performed on the backend at computing device 102.

Forecasting and processing environment 108 provides components for context-specific forecasting and data request processing. In some examples, forecasting and processing environment 108 includes consumption analytics module 120 and data control module 122.

Consumption analytics module 120 is a component of forecasting and processing environment 108 that receives data requests for consumption units, identifies forecasted consumption values for the consumption units, determines threshold factors, and generates forecasted values, allowance thresholds, and other notifications and reports associated with the consumption unit. Data control module 122 is a component of forecasting and processing environment 108 that identifies data requests that are subject to adjustment based on values and thresholds generated by consumption analytics module 120, and controls the processing of the data requests received by consumption analytics module 120 in order to generate replenishment requests.

As one example, consumption analytics module 120 receives a data request for a consumption unit, including an attempted data request value, the data request associated with an individual environment and corresponding to a given period of time. The data request for a consumption unit may be a user attempt to order a quantity of the consumption unit for an individual environment, such as a specific physical store location, for example. The user in this example may be a store employee with credentials or permissions to manage consumption unit inventory for that store, in an illustrative example. The given period of time may refer to pre-configured time span, such as a week, for which orders for consumption units are placed. The pre-configured time span may be any length of time associated with a data request, and may be configured based on any number of factors. For example, a store may place weekly orders for consumption units in order to have a necessary number of units on-hand for the business demands of a week while maintaining inventory space and budget allocations for other business necessities rather than stock-piling consumption units for a longer span of time, such as a year, which may put a strain on physical storage space and/or budgets.

As another example, consumption analytics module 120 identifies a forecasted consumption value for the consumption unit of a data request, the forecasted consumption value corresponding to the individual environment and the given period of time. Consumption analytics module 120 may compute the forecasted consumption value, or may identify a pre-computed forecasted consumption value stored in memory and associated with the individual environment and the given period of time. The forecasted consumption value refers to the forecasted quantity of consumption units that is needed for the individual environment, such as a specific store, for that given period of time identified in the request. The given period of time may identify a specific date range or a time span, depending upon the configuration settings. For example, the request may be for a particular size bag, for a specific physical store location, for the second week of the second month of the year. Consumption analytics module 120 identifies, by computation or determining a pre-computed value, the forecasted quantity needed for that particular size bag, for that specific physical store location, for that specific week of the year to provide the forecasted consumption value.

In some examples, threshold factors may be factored into the data request for a consumption unit. Consumption analytics module 120 determines a threshold factor for the consumption unit, the threshold factor corresponding to the individual environment and the given period of time. A threshold factor may include, without limitation, quantity threshold, a lift threshold, a reverse lift threshold, a lead time threshold, or a budgetary threshold, for example. A quantity threshold may be a threshold value per consumption unit per individual environment per given period of time. In other words, in some examples, a quantity threshold may be time period-specific, environment-specific, consumption-unit specific, budget-specific, or any combination of time period-specific, environment-specific, consumption-unit specific, or budget-specific. In other examples, the quantity threshold may be variable based on any one of a given time period, a given environment, and a given consumption unit.

A quantity threshold may also be tied to a maximum quantity allowed factor for a data request or a maximum quantity allowed factor for current inventory. A maximum quantity allowed factor may be tied to a budget, such as a budget for an overall environment or a budget for an individual environment, for example. As an example, a maximum quantity allowed factor for a data request may set a quantity threshold for a consumption unit so that any data request for the consumption unit, regardless of environment or time period, may not exceed the quantity threshold. As another example, a maximum quantity allowed factor may set a quantity threshold for a consumption unit associated with a specific individual location, such that a request for that consumption unit from that location may not exceed the quantity threshold. As yet another example, a maximum quantity allowed factor may set a quantity threshold for a consumption unit associated with a specific individual location and a given time period, such that a request for that consumption unit from that location for that time period may not exceed the quantity threshold. In some aspects of this disclosure, a maximum quantity allowed factor may be applied to a current inventory value, so that any request for a value that when aggregated with a current inventory would exceed the threshold is adjusted to meet the quantity threshold by the data control module.

A lift threshold refers to a value set by a lift factor. The lift factor may be based on an indexed value of a forecasted consumption value in some examples. For a lift factor based on an index, consumption analytics module 120 computes an indexed value of a forecasted consumption value, in which the indexed value takes into account historical or corresponding context-specific forecasted consumption values to provide a context-specific adjustment of a forecasted value. As an example, where a given time period is a specific week of the current year, and the forecasted consumption value is based on that specific week for an individual environment, an indexed value takes into account a corresponding time period, such as the specific week of the previous year, and the consumption unit value for that corresponding time period, to adjust the value in a context-specific manner. The lift may be an increase in the allowance threshold generated based on the forecasted consumption value for a data request, for example.

In other examples, the lift factor may be based on a pre-configured percentage associated with a specific individual environment, such as an allotted lift percentage for a specific store. In this example, data control module may access stored data associated with an individual environment to identify a lift value, or percentage, allocated for that individual environment. As an illustrative example, store-1 may have a 10% allocation, store-2 may have a 15% lift allocation, and store-3 may have a 30% lift allocation, which provides data control module with a specific lift factor for each individual environment when processing a data request for that individual environment.

A reverse lift threshold is the opposite of a lift threshold, providing a decrease in the allowance threshold generated based on the forecasted consumption value. A lead time threshold may cause the consumption analytics module to take into account a delivery window or delivery delay time of the consumption unit being requested, in order to maintain the necessary inventory at an individual environment or location.

Data control module 122 determines whether to adjust a data request based in part on data generated by consumption analytics module 120. Data control module 122 may determine whether to adjust a data request based in part on the allowance threshold generated by consumption analytics module 120 and the attempted data request value of the data request received, for example. In some examples, regulation components 124 may be implemented on consumption analytics module and/or data control module (as shown) to provide configurable regulation factors, which data control module may take into account when determining whether to adjust the data request and generate a replenishment order. Regulation components 124 may include a deduplication component, for example, which enables data control module 122 to identify and reject duplicate data requests, or otherwise modify or adjust data requests based on a detected duplicate request.

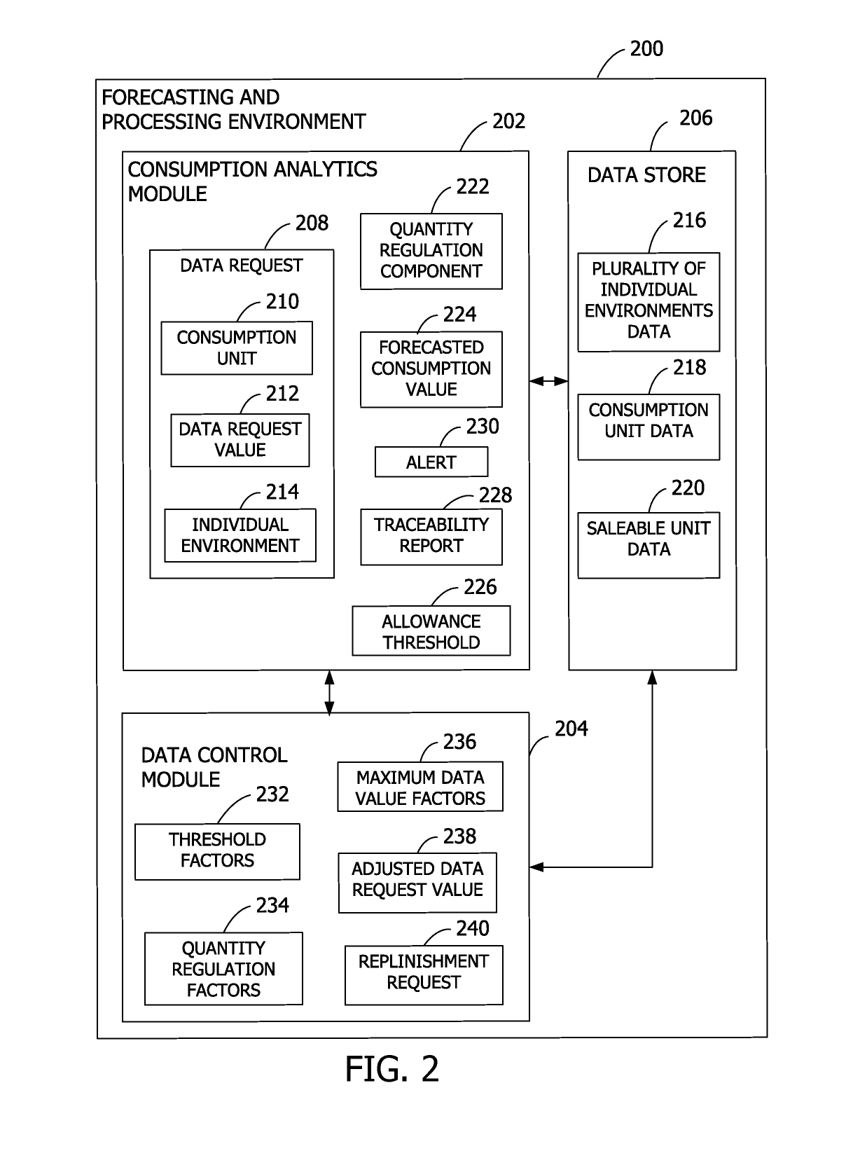

FIG. 2 is an exemplary block diagram illustrating a forecasting and processing environment for context-specific forecasts of consumption units. Forecasting and processing environment 200 is an illustrative example of one implementation of forecasting and processing environment 108 in FIG. 1. Forecasting and processing environment 200 includes consumption analytics module 202, data control module 204, and data store 206.

Consumption analytics module 202 receives data request 208, which includes consumption unit 210, data request value 212, and individual environment 214. Consumption unit 210 may be a unique identifier of a physical consumption unit, or a representation of the physical consumption unit. Data request value 212 may represent an input value, or attempted order quantity, for the consumption unit. Individual environment 214 may be a unique identifier of a physical location, such as a specific store location, or otherwise a representation of a specific store location.

Data store 206 may be implemented within forecasting and processing environment 200, as depicted in the illustrative example of FIG. 2, or alternatively may be located remote from and communicatively coupled to forecasting and processing environment 200 (not shown). Consumption analytics module 202 may access plurality of individual environments data 216, consumption unit data 218, and saleable unit data 220 at data store 206. Plurality of individual environments data 216 may include information, not limited to, budgets tied to a specific environment, budgets tied to a specific consumption unit, historical saleable units sold for a specific environment, historical consumption units associated with a specific environment, prior forecasted consumption values for given time periods for a specific environment, threshold factors or regulation factors assigned or activated for a specific environment, eligibility data associated with a consumption unit for a specific environment, and any other suitable data or information associated with a specific environment.

As an example, data for an individual environment may indicate that the budget for the individual environment has been exceeded for a particular consumption unit for a given period of time, but that historically the overall environment experiences increased sales for the given period of time and utilizes increased consumption units during the increased sales period at other individual environments. As another example, data for an individual environment may indicate that the individual environment is not eligible to request and/or receive a specific consumption unit.

Consumption unit data 218 may include information not limited to detailed descriptions of a consumption unit, cost of a consumption unit, quantity values of an individual consumption unit per packaged unit, images or representations of a consumption unit, threshold factors and/or regulation factors tied to a consumption unit, and any other suitable data or information associated with a specific consumption unit.

Saleable unit data 220 may include information not limited to detailed descriptions of a saleable unit, including size, form factor, weight, and/or dimensions; cost of a saleable unit, relational value of a saleable unit to one or more consumption units, images or representations of a saleable unit, and any other suitable data or information associated with a specific saleable unit. In these examples, a relational value of a saleable unit to one or more consumption units refers to an adjusted unit value that takes into account the impact of the saleable unit on the one or more consumption items.

For example, in a grocery environment saleable units may include raw meat, dairy products, produce, canned goods, beverages, and so on, while a consumption unit may include a plastic grocery sack. In this example, the saleable units of canned goods may have a relational value of 4:1 to the consumption unit of the plastic grocery sack, with one plastic grocery sack allotted for every four cans of canned goods sold in order to adequately bag and contain the sold goods for the consumer purchase. In this same scenario, a saleable unit of raw meat may have a 1:1 relational value to a plastic grocery sack, to account for the typical practice of allotting a whole sack to the raw meat in order to keep that item separate from other grocery items, for example. When the saleable units of an individual environment are taken into account by the consumption analytics module upon receipt of a data request, part of calculating the forecasted consumption value includes calculating an adjusted unit value based on the relational value of the particular saleable goods of that specific environment and the specific consumption unit being requested.

As another example, some saleable units have a dimension or form factor that is incompatible with a consumption unit, and these incompatible units may be taken into account as well when adjusting the unit value for a forecasted consumption unit value.

The adjusted unit value may be calculated by calculating the total units sold of saleable units with the relational value of related saleable units and the relational value of unrelated saleable units. For example, Equation (1) below shows calculation of the adjusted unit value:

Total Saleable Units Sold−Unrelated Units+[Related Units×Relational Value]=Adjusted Unit Value (1)

Consumption analytics module 202 may calculate a consumption unit value for consumption unit 210 by indexing the adjusted unit value. The index may be a year-over-year index, in one example. The index value used to index the adjusted unit value is based on a calculation of an aggregate adjusted unit value for an adjacent relative time period and a corresponding aggregate adjusted unit value for a corresponding relative time period. For example, Equations (2) and (3) below show calculation of the index value and the consumption unit value:

Aggregate Adjusted Unit Value±Corresponding Aggregate Adjusted Unit Value=Index Value (2)

Adjusted Unit Value×Index Value=Consumption Unit Value (3)

Consumption analytics module 202 may also include quantity regulation component 222 that provides an indication to data control module 204 as to whether a quantity regulation factor is a threshold factor for data request value adjustment. Quantity regulation component 222 may be a configurable component that provides a business environment with the option to configure a quantity regulation threshold or factor for an individual environment, for a group of individual environments, or for an entire business environment, for example. In some examples, the quantity regulation component is configured as a Boolean field, allowing a quantity threshold to be activated or deactivated for a specific environment.

Consumption analytics module 202 receives data request 208, identifies forecasted consumption value 224 for consumption unit 210, and generates allowance threshold 226 for consumption unit 210 for individual environment 214. Allowance threshold 226 is a threshold value for an allowed order request or quantity request for consumption unit 210 by individual environment 214 for a given time period associated with data request 208. Allowance threshold 226 may be generated as part of traceability report 228 in some examples. Traceability report 228 may be generated for a plurality of data requests, including data request 208, received during a given period of time or request window, such as an order submission window for example. Traceability report 228 may include information not limited to an item description for the consumption unit or consumption units requested, a user name or other identifier of a user placing the request for that consumption unit, a date the request was made, an order number associated with the request, a vendor identifier, an item number or other unique identifier of the consumption unit, a store number or other unique identifier of the individual environment, a requested quantity value or an attempted data request value, a forecasted consumption value, an on-hand quantity of the consumption unit, and any other suitable information related to a data request for a consumption unit. Consumption analytics module 202 may also generate alert 230 upon detecting that data request value 212 exceeds forecasted consumption value 224 for consumption unit 210, in some examples. Alert 230 may be output to an interface, such as interface 118 in FIG. 1 to notify a user associated with data request 208 that the requested quantity may be adjusted when processed by data control module 204.

Consumption analytics module 202 provides traceability report 228, including allowance threshold 226 and forecasted consumption value 224, to data control module 204. Data control module 204 processes traceability report 228 using threshold factors 232, quantity regulation factors 234, and maximum data value factors 236 to determine whether adjusted data request values are needed, and as needed generates adjusted values for data requests of traceability report 228, such as adjusted data request value 238 for data request 208, as an illustrative example. The adjusted data request value 238 is used by data control module to generate replenishment request 240, which may be transmitted or output to a supplier of consumption units for order fulfillment. In this way, aspects of the disclosure provide a context-specific forecast for a consumption unit while controlling order requests and processing of the consumption unit to maintain budgetary concerns as well as context-specific business needs.

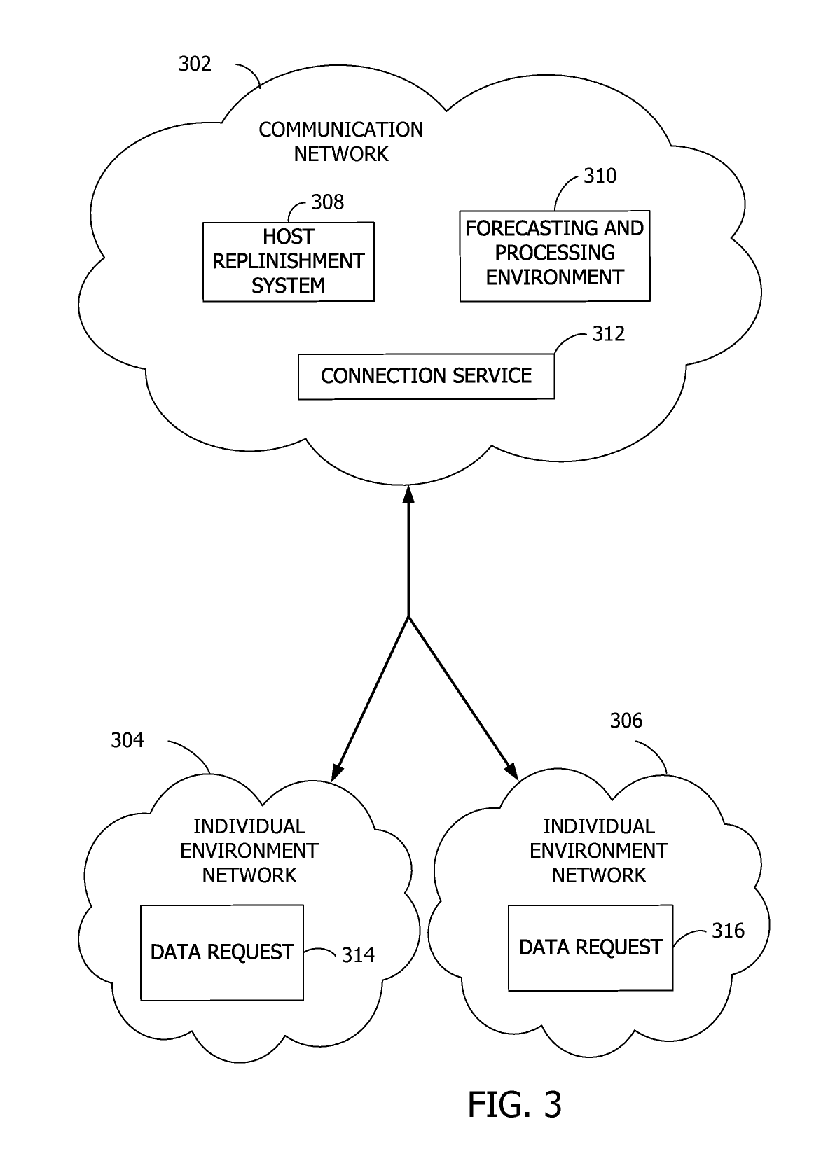

FIG. 3 is an exemplary diagram illustrating network communication with a forecasting and processing environment for context-specific forecasts. Forecasting and processing environment 310 may be an illustrative example of one implementation of developer forecasting and processing environment 108 in FIG. 1 and/or forecasting and processing environment 200 in FIG. 2.

Communication network 302 is communicatively coupled to individual environment network 304 and individual environment network 306. An individual environment network may be a local area network of an individual location, such as physical store location in some examples. Communication network 302 may comprise a cloud hosting forecasting and processing environment 310 and host replenishment system 308, in some examples, and including connection service 312 to provide for communication between individual environment network 304, individual environment network 306, and the hosted systems and environments of communication network 302. Connection service 312 may have knowledge of protocols and other information needed to communicate with the back-end services associated with individual environment networks, for example.

An individual location may generate data request 314, which is communicated via communication network 302 to forecasting and data processing environment 310, for example. Another individual location may generate data request 316, which is communicated via communication network 302 to forecasting and data processing environment 310. Data processing environment 310 may receive data request 314 associated with one location and data request 316 associated with another location and provide a context-specific consumption unit forecast specific to each location, as described above.

FIG. 4 is an exemplary flow chart illustrating operation of the computing device to generate a forecasted consumption value for a consumption unit. The exemplary operations presented in FIG. 4 may be performed by one or more components described in FIG. 1 or FIG. 2, for example.

The process receives a data request for a consumption unit associated with an individual environment at operation 402. The data request is received by a consumption analytics module within a forecasting and processing environment, for example. The data request may include a data request value, an identifier of a consumption unit, a given time period, and an identifier of an individual environment.

The process obtains data related to the consumption unit, the individual environment, and saleable units associated with the individual environment at operation 404. The data obtained may be specific to the individual environment and a given time period, and may also include historical data for a corresponding time period or an adjacent time period, in some examples.

The process computes an adjusted unit value of the consumption unit for a given time period at operation 406. The given time period may be a date range, or a time span, for example, such as a specific week in a current year, or a time span of the next consecutive five days, or any other suitable time period. The process determines whether there is an aggregate adjusted unit value associated with a relative time period adjacent to the given time period at operation 408. A relative time period adjacent to the given time period may be a pre-configured business-determined time period, such as the preceding four weeks relative to the given time period. An aggregate adjusted unit value may be a computation of the adjusted unit values of individual time periods within the relative time period, such as an aggregate of the adjusted unit values for each week of a four-week period. The aggregate adjusted unit value may be a pre-computed value stored in association with the individual environment, and located in individual environment date, such as plurality of individual environments data 216 in FIG. 2.

Responsive to a determination that there is an aggregate adjusted unit value associated with a relative time period adjacent to the given time period, the process identifies a corresponding aggregate adjusted unit value associated with the corresponding time period at operation 410. As used herein, adjacent may refer to an adjoining, or a recent but not adjoining, time period. The corresponding time period may be a pre-configured business-determined time period, such as the same time span or date range as the relative time period adjacent to the given time period but for a previous or different year, thus corresponding to the relative time period adjacent to the given time period. The corresponding aggregate adjusted unit value may be a similar pre-computed value stored in association with the individual environment for that corresponding time period.

The process calculates an index value based on the aggregate adjusted unit value and the corresponding aggregate adjusted unit value at operation 412. The process generates a consumption unit value for the consumption unit at operation 414. Responsive to a determination that there is not an aggregate adjusted unit value associated with a relative time period adjacent to the given time period at operation 408, the process moves to operation 414 and generates a consumption unit value for the consumption unit.

The process identifies a composite consumption value associated with a region corresponding to the individual environment at operation 416. The composite consumption value is a value tied to the consumption unit by a group of individual environments or a region of individual environments, such as an average number of saleable units per consumption unit based on a region or group of environments. The process then generates a forecasted consumption value of the consumption unit based on the generated consumption unit value and the composite consumption unit value at operation 418, with the process terminating thereafter.

FIG. 5 is an exemplary flow chart illustrating operation of the computing device to control a data request process for a consumption unit. The exemplary operations presented in FIG. 5 may be performed by one or more components described in FIG. 1 or FIG. 2, for example.

The process receives a data request with an attempted data request value for a consumption unit at operation 502. The attempted data request value may be a user input value for a requested quantity of the consumption unit, for example. The process identifies a forecasted consumption value of the consumption unit for the individual environment associated with the received data request at operation 504.

The process determines whether there is an active threshold factor for the consumption unit at operation 506. If the process determines that there is not an active threshold factor, the process sets the threshold value to zero at operation 508. If the process determines that there is an active threshold factor, the process identifies a threshold value for the active threshold factor at operation 510. The process then calculates an allowance threshold for the consumption unit based on the forecasted consumption value and the threshold value at operation 512.

The process determines whether the attempted data request value is more than the allowance threshold at operation 514. If the process determines that the attempted data request value is more than the allowance threshold, the process adjusts the data request value based on the allowance threshold at operation 516. If the process determines that the attempted data request value is not more than the allowance threshold, the process continues to process the received data request using the attempted data request value at operation 518.

The process determines whether a quantity regulation factor is activated at operation 520. If the process determines that a quantity regulation factor is activated, the process adjusts the data request value based on the active quantity regulation factor at operation 522 and proceeds to operation 524. If the process determines that a quantity regulation factor is not activated, the process generates an adjusted data request value at operation 524, with the process terminating thereafter.

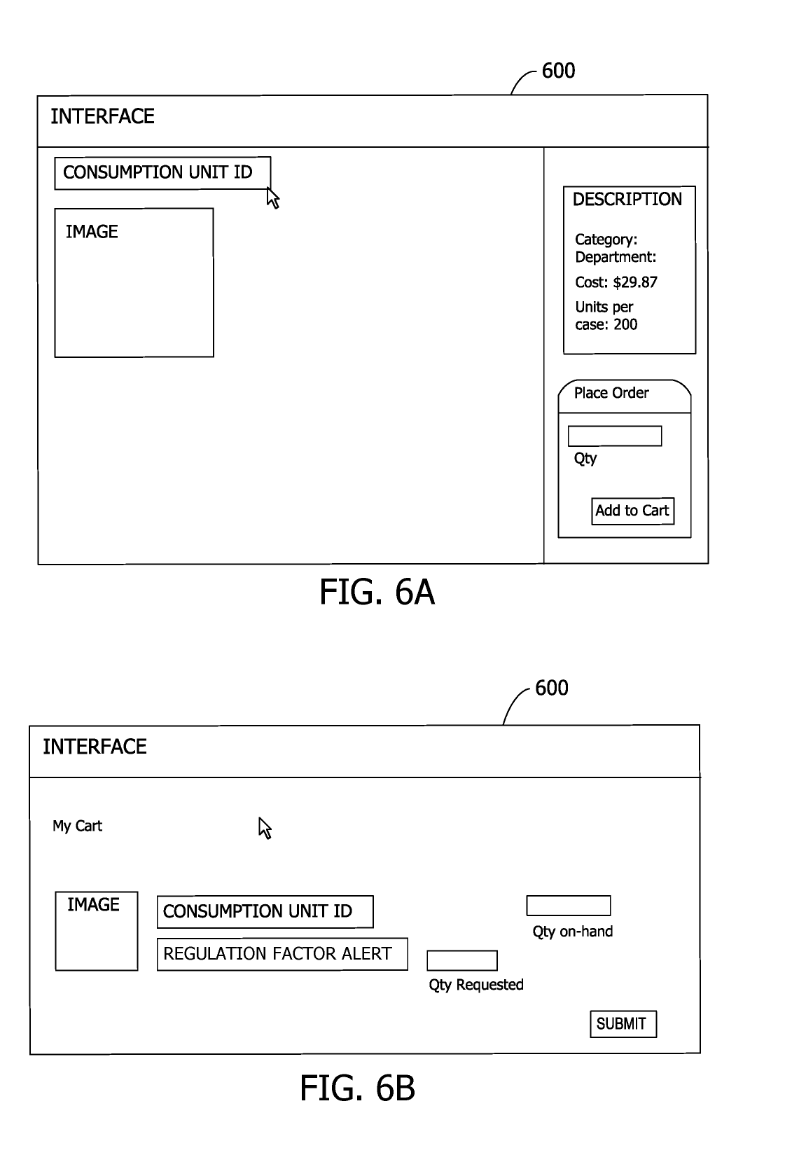

FIGS. 6A & 6B are exemplary diagrams illustrating an interface for interacting with the forecasting and processing environment. Interface 600 may be an illustrative example of a graphical user interface displaying a forecasting and processing environment, or an instance of a forecasting and processing system, for example.

Interface 600 depicts a data request interface that a user may interact with in order to generate a data request for a consumption unit, for example. FIG. 6A depicts a graphical display that provides a consumption unit identifier and image to identify the consumption unit being contemplated by the user for the request. FIG. 6A depicts a description of the consumption unit identified, and an order placement section of the interface, where a field may be provided to capture user input associated with a desired quantity of the consumption unit. As an example, a user may input a quantity value in the quantity field that represents a data request value for the consumption unit.

FIG. 6B depicts a shopping cart view for representing selections and quantities made by a user interacting with interface 600 to generate a data request. A quantity on-hand field may be provided and a regulation factor alert may be displayed to notify a user that the quantity on-hand field is a required filed for order submission. In this example, a quantity regulation component may be activated for the individual environment associated with the attempted order request being generated as a result of the user interaction with interface 600.

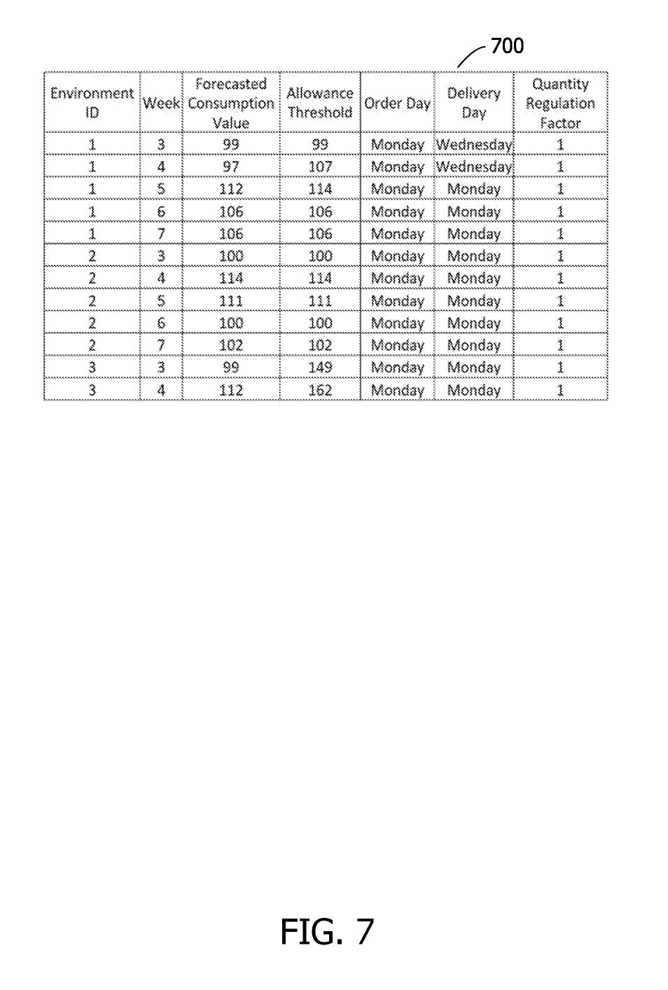

FIG. 7 is an exemplary table illustrating context-specific forecasts and thresholds. Table 700 illustrates data and information that may be generated by consumption analytics module 120 in FIG. 1 and stored in plurality of individual environment data 216 in FIG. 2, specific to a particular consumption unit, in some examples. In other examples, table 700 illustrates data generated by consumption analytics module 202 as part of traceability report 228 in FIG. 2.

The illustrative data of table 700 depicts the context-specific nature of the forecasted consumption values and allowance thresholds, which control the processing of data requests for an individual environment and consumption unit. The environment identification column provides a unique identifier of a specific location, such as a physical store location. The week column indicates a specific time span or given time period for that individual environment. The forecasted consumption value column identifies the forecasted consumption unit value calculated by the consumption analytics module for the specific consumption unit relative to the specific given time period and specific individual environment. The allowance threshold column provides the specific allowance threshold generated by the consumption analytics module for the specific consumption unit relative to the specific given time period and specific individual environment. As can be seen in the illustrative data provided for exemplary purposes in table 700, environment-1 has an allowance threshold equal to the forecasted consumption value for the given time period of week-3, but an increased allowance threshold for week-4. This increase in week-4 may be due to a calculated lift, an indexed value, or some other factor computed when the consumption analytics module generated the allowance threshold for that specific consumption unit and individual environment.

Order day and delivery day columns indicate the potential for delivery delay or lead time for an order, which may be another factor taken into account by data control module when processing the data request and determining whether any adjustments are to be made. The quantity regulation factor column identifies whether the quantity regulation component is activated for an individual environment. In the illustrative example of table 700, the quantity regulation component is a Boolean field, and the numeral one indicates the component is activated for all environments identified in table 700. A numeral zero (not shown) may indicate that the component is not activated for a given environment, in this example.

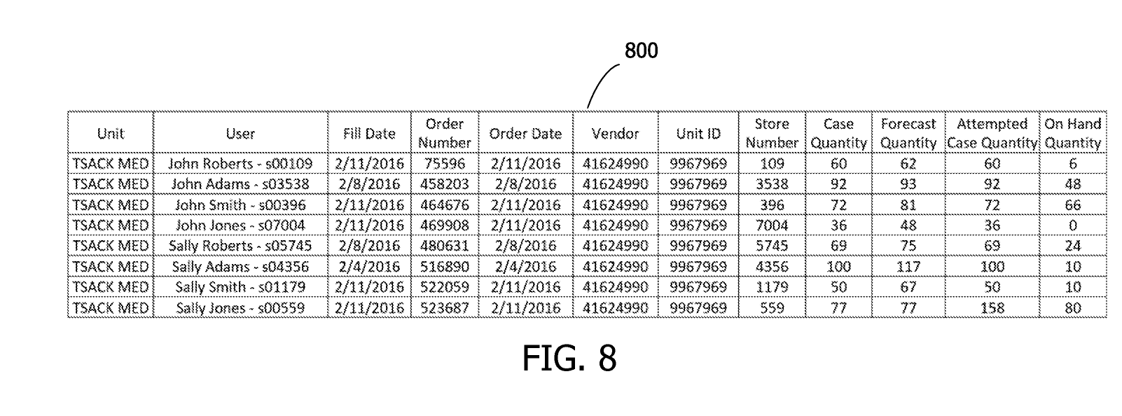

FIG. 8 is an exemplary table illustrating context-specific forecasts and regulations. Table 800 may be an illustrative example of traceability report 228 generated by consumption analytics module 202 and obtained by data control module 204 for use in generating replenishment request 240, for example.

Table 800 illustrates data identifying a consumption unit, such as a medium t-sack (TSACK MED), which may be a plastic bag used in a retail environment to contain consumer goods purchased at the retail environment, for example. A user name is associated with an order placed on a date for a specific item, the consumption unit, and a specific location, as indicated by the store number. The data includes information on attempted order quantities, forecasted quantities, and on-hand quantities, to provide data that the data control module uses to determine if any adjustments are to be made to requested order quantities in order to generate a replenishment request that meets the needs of the business while satisfying restrictions placed on consumable resources of the business.

### Additional Examples

In some examples, a year-over-year index value is calculated for a consumption unit based on a discrepancy between an adjacent relevant time period and a corresponding relevant time period. For example, if the adjacent relevant time period is the four-week period preceding the week associated with the data request, and the corresponding relevant time period is the same four-week period in the previous year, and a discrepancy exists between the aggregate adjusted unit values of the adjacent and corresponding time periods, indexing is performed to lift or reverse lift the adjusted unit value for that consumption unit. This may account for new environments, an environment converting from one type of store to another type of store with different capacity or inventory, natural growth of an environment, or any other suitable change in an environment from year to year.

In other examples, a business environment may allow a lift of fifteen percent for orders associated with a consumption unit for an individual store location. In this example, if the individual store attempts to order a quantity of 500 consumption units, and the forecast value is 92, the allowed lift of fifteen percent would allow 120 consumption units to be ordered, providing a lift threshold that prompts the data control module to adjust the data request value of 500 to 120, despite the forecast value of 92. In this scenario, if the on-hand quantity regulation component was activated for this individual location, and the on-hand quantity regulation factor has a threshold value of seventy-five percent, the consumption analytics module would prompt the user placing the order request to input a quantity value for on-hand inventory of the consumption unit. If the on-hand quantity value input is fifteen, data control module calculates seventy-five percent of 15—the on-hand quantity value—and subtracts that from the allowed value per the lift threshold. So in this exemplary scenario, Equation (4) below calculates the quantity of units, and Equation (5) below calculates the quantity of consumption units:

15 on-hand quantity value×75% quantity regulation factor=11 units (4)

120 allowed consumption units per lift−11 units per quantity regulation factor=109 consumption units allowed for this order request (5)

A lift may fluctuate by location. In some examples, locations with more accurate order or data request history may be allowed a higher lift percentage, or buffer, for consumption unit requests.

In addition, lead time thresholds may be factored into an allowed order quantity or data request value. In some examples, a set delivery day for a supplier of a consumption unit is known, per individual location, and a lead time for delivery from the time of the request may be calculated. A per-day forecasted consumption unit value may be calculated for the consumption unit, and the per-day forecasted consumption unit value may be multiplied by the calculated lead time to determine if the resulting value is equal to or less than zero. If the resulting value is equal to or less than zero, an increase in the allowed data request value may be calculated to adjust for the lead time and anticipated lack of inventory should the forecasted value by used without factoring in the lead time, for example.

In some examples, the forecasting and processing environment may generate automatic replenishment solutions for individual environments without input from the individual environment based on the plurality of individual environments data, consumption unit data, and saleable unit data obtained at the data store. In these examples, the auto-replenishment solutions may be generated and the associated consumptions units sent out for delivery to the individual environment without receiving a specific data request.

Alternatively, or in addition to the other examples described herein, examples include any combination of the following:
wherein the consumption analytics module is further configured to generate the forecasted consumption value for the consumption unit using an indexed consumption unit value computed from an adjusted unit value for a given time period associated with an individual environment;
wherein the consumption analytics module outputs an alert to the interface on condition that the attempted data request value exceeds the forecasted consumption value for the consumption unit, the alert notifying a user that a data request is subject to adjustment by the data control module;
wherein the consumption analytics module outputs a traceability report to the interface;
wherein the consumption analytics module outputs a traceability report to the data control module, and wherein the data control module automatically generates a replenishment request using the traceability report and one or more threshold factors;
wherein the one or more threshold factors include at least one of a quantity threshold, a lift threshold, a reverse lift threshold, or a lead time threshold;
a quantity regulation component, the quantity regulation component configured to provide an indication to the data control module as to whether a quantity regulation factor is a threshold factor for order adjustment;
wherein the quantity regulation component is configured as a Boolean field;
identifying a total units sold value corresponding to the given time period for the saleable units associated with the individual environment;
determining whether at least a portion of the total units sold are unrelated to the consumption unit;
responsive to determining that at least the portion of the total units sold are unrelated to the consumption unit, generating an unrelated unit value;
subtracting the unrelated unit value from the total units sold value to generate the adjusted unit value;
identifying a total units sold value corresponding to the given time period for the saleable units associated with the individual environment;
determining whether at least a portion of the total units sold has an adjusted relational value to the consumption unit;
responsive to determining that at least the portion of the total units sold has an adjusted relational value to the consumption unit, generating an adjusted relational unit value;
calculating the adjusted relational unit value and the total units sold value to generate the adjusted unit value;
identifying a relative time period adjacent to the given time period for a given year and an aggregate adjusted unit value associated with the relative time period;
determining a corresponding time period to the relative time period for another year and a corresponding aggregate adjusted unit value associated with the corresponding time period;
calculating a year over year index value based on the aggregate adjusted unit value and the corresponding aggregate adjusted unit value, the year over year index value used to generate the consumption unit value;
wherein the year over year index value is at least one of a lift or a reverse lift;
wherein the consumption unit related to at least one of the one or more saleable units is at least one of a plastic bag, paper bag, reusable container, or disposable container;
determining whether the individual environment is allocated a threshold factor;
responsive to determining that the individual environment is allocated a threshold factor, identifying an allowed threshold value for the individual environment;
calculating the identified allowed threshold value based on the generated forecasted consumption value to generate a maximum data value for the given time period and the consumption unit;
determining whether a quantity regulation factor is activated for the individual environment;
responsive to determining that the quantity regulation factor is activated, identifying a quantity deduction value associated with the individual environment;
calculating the identified allowed threshold value based on the generated forecasted consumption value and the quantity deduction value to generate the maximum data value for the given time period and the consumption unit;
outputting a traceability report, including an identifier of the consumption unit, a unique identifier for the individual environment, a unique identifier of a user associated with a data request for the consumption unit for the individual environment, a data request date, the forecasted consumption value for the consumption unit for the given period of time based on the data request date, an attempted data request value, a quantity value for the consumption unit associated with the individual environment, and an allowed data request value for the consumption unit associated with the individual environment;
determines whether the attempted data request value is less than or equal to the allowance threshold;
responsive to determining the attempted data request value is less than or equal to the allowance threshold, processes the data request using the attempted data request value;
responsive to determining that the attempted data request value exceeds the allowance threshold, adjusts the attempted data request value based on the allowance threshold to generate an adjusted data request value;
determines whether a quantity regulation factor is activated for the individual environment;
responsive to determining that the quantity regulation factor is activated, identifies a quantity deduction value associated with the individual environment;
adjusts the attempted data request value based on the allowance threshold less the quantity deduction value to generate the adjusted data request value.

In some examples, the operations illustrated in FIG. 4 and FIG. 5 may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

### Exemplary Operating Environment

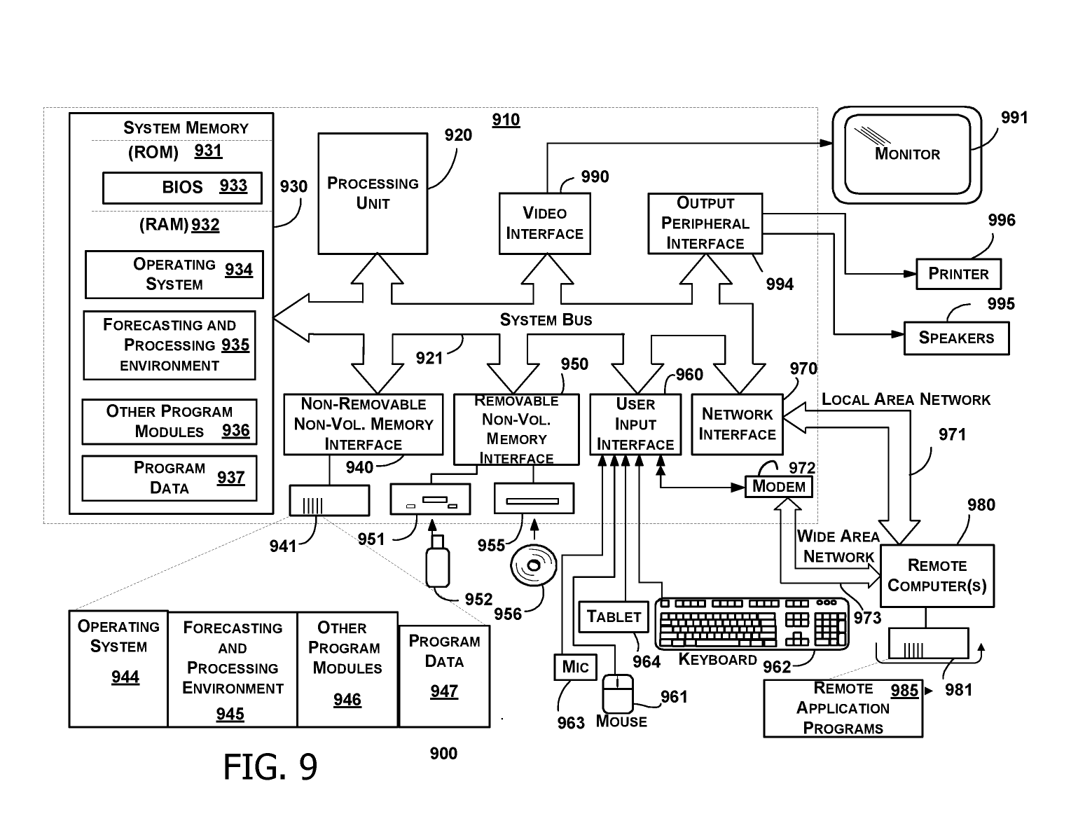

FIG. 9 illustrates an example of a suitable computing and networking environment 900 on which the examples of FIG. 1 may be implemented. The computing system environment 900 is only one example of a suitable computing environment and is not intended to suggest any limitation as to the scope of use or functionality of the disclosure. Neither should the computing environment 900 be interpreted as having any dependency or requirement relating to any one or combination of components illustrated in the exemplary operating environment 900.

The disclosure is operational with numerous other general purpose or special purpose computing system environments or configurations. Examples of well-known computing systems, environments, and/or configurations that may be suitable for use with the disclosure include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, and so forth, which perform particular tasks or implement particular abstract data types. The disclosure may also be practiced in distributed computing environments where tasks are performed by remote processing devices that are linked through a communications network. In a distributed computing environment, program modules may be located in local and/or remote computer storage media including memory storage devices and/or computer storage devices. As used herein, computer storage devices refer to hardware devices.

With reference to FIG. 9, an exemplary system for implementing various aspects of the disclosure may include a general purpose computing device in the form of a computer 910. Components of the computer 910 may include, but are not limited to, a processing unit 920, a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 910 typically includes a variety of computer-readable media. Computer-readable media may be any available media that may be accessed by the computer 910 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or the like. Memory 931 and 932 are examples of computer storage media. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by the computer 910. Computer storage media does not, however, include propagated signals. Rather, computer storage media excludes propagated signals. Any such computer storage media may be part of computer 910.

Communication media typically embodies computer-readable instructions, data structures, program modules or the like in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The system memory 930 includes computer storage media in the form of volatile and/or nonvolatile memory such as read only memory (ROM) 931 and random access memory (RAM) 932. A basic input/output system 933 (BIOS), containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 9 illustrates operating system 934, application programs, such as forecasting and processing environment 935, other program modules 936 and program data 937.

The computer 910 may also include other removable/non-removable, volatile/nonvolatile computer storage media. By way of example only, FIG. 9 illustrates a hard disk drive 941 that reads from or writes to non-removable, nonvolatile magnetic media, a universal serial bus (USB) port 951 that provides for reads from or writes to a removable, nonvolatile memory 952, and an optical disk drive 955 that reads from or writes to a removable, nonvolatile optical disk 956 such as a CD ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 941 is typically connected to the system bus 921 through a non-removable memory interface such as interface 940, and USB port 951 and optical disk drive 955 are typically connected to the system bus 8921 by a removable memory interface, such as interface 950.

The drives and their associated computer storage media, described above and illustrated in FIG. 9, provide storage of computer-readable instructions, data structures, program modules and other data for the computer 910. In FIG. 9, for example, hard disk drive 941 is illustrated as storing operating system 944, forecasting and processing environment 945, other program modules 946 and program data 947. Note that these components may either be the same as or different from operating system 934, forecasting and processing environment 935, other program modules 936, and program data 937. Operating system 944, forecasting and processing environment 945, other program modules 946, and program data 947 are given different numbers herein to illustrate that, at a minimum, they are different copies. A user may enter commands and information into the computer 910 through input devices such as a tablet, or electronic digitizer, 964, a microphone 963, a keyboard 962 and pointing device 961, commonly referred to as mouse, trackball or touch pad. Other input devices not shown in FIG. 9 may include a joystick, game pad, satellite dish, scanner, or the like. These and other input devices are often connected to the processing unit 920 through a user input interface 960 that is coupled to the system bus, but may be connected by other interface and bus structures, such as a parallel port, game port or a universal serial bus (USB). A monitor 991 or other type of display device is also connected to the system bus 921 via an interface, such as a video interface 990. The monitor 991 may also be integrated with a touch-screen panel or the like. Note that the monitor and/or touch screen panel may be physically coupled to a housing in which the computing device 910 is incorporated, such as in a tablet-type personal computer. In addition, computers such as the computing device 910 may also include other peripheral output devices such as speakers 995 and printer 996, which may be connected through an output peripheral interface 994 or the like.

The computer 910 may operate in a networked environment using logical connections to one or more remote computers, such as a remote computer 980. The remote computer 980 may be a personal computer, a server, a router, a network PC, a peer device or other common network node, and typically includes many or all of the elements described above relative to the computer 910, although only a memory storage device 981 has been illustrated in FIG. 9. The logical connections depicted in FIG. 9 include one or more local area networks (LAN) 971 and one or more wide area networks (WAN) 973, but may also include other networks. Such networking environments are commonplace in offices, enterprise-wide computer networks, intranets and the Internet.

When used in a LAN networking environment, the computer 910 is connected to the LAN 971 through a network interface or adapter 970. When used in a WAN networking environment, the computer 910 typically includes a modem 972 or other means for establishing communications over the WAN 973, such as the Internet. The modem 972, which may be internal or external, may be connected to the system bus 921 via the user input interface 960 or other appropriate mechanism. A wireless networking component such as comprising an interface and antenna may be coupled through a suitable device such as an access point or peer computer to a WAN or LAN. In a networked environment, program modules depicted relative to the computer 910, or portions thereof, may be stored in the remote memory storage device. By way of example, and not limitation, FIG. 9 illustrates remote application programs 985 as residing on memory device 981. It may be appreciated that the network connections shown are exemplary and other means of establishing a communications link between the computers may be used.

The examples illustrated and described herein as well as examples not specifically described herein but within the scope of aspects of the disclosure constitute an exemplary context-specific forecasting device and a context-specific forecasting and processing environment. For example, the elements illustrated in FIG. 1 and FIG. 2, such as when encoded to perform the operations illustrated in FIG. 4 and FIG. 5, constitute exemplary means for receiving a data request for a consumption unit, exemplary means for obtaining data related to the consumption unit and an associated individual environment, and exemplary means for determining a forecasted consumption value for the consumption unit associated with the individual environment.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure is susceptible to various modifications and alternative constructions, certain illustrated examples thereof are shown in the drawings and have been described above in detail. It should be understood, however, that there is no intention to limit the disclosure to the specific forms disclosed, but on the contrary, the intention is to cover all modifications, alternative constructions, and equivalents falling within the spirit and scope of the disclosure.

What is claimed is:

1. A system for context-specific consumption forecasting, the system comprising:
an interface coupled to a communication network;
at least one processor coupled to the interface via the communication network;
a consumption analytics module, implemented on the at least one processor, that:
receives a data request for a consumption unit, including an attempted data request value, the data request associated with an individual environment and corresponding to a given period of time;
identifies a forecasted consumption value for the consumption unit, the forecasted consumption value corresponding to the individual environment and the given period of time;
determines a threshold factor for the consumption unit, the threshold factor corresponding to the individual environment and the given period of time; and
generates an allowance threshold for the data request; and
a data control module implemented on the at least one processor, communicatively coupled to the consumption analytics module via the communication network, that determines whether to adjust the data request based on the generated allowance threshold and the attempted data request value.

2. The system of claim 1, wherein the consumption analytics module is further configured to generate the forecasted consumption value for the consumption unit using an indexed consumption unit value computed from an adjusted unit value for a given time period associated with the individual environment.

3. The system of claim 1, wherein the consumption analytics module outputs an alert to the interface on condition that the attempted data request value exceeds the forecasted consumption value for the consumption unit, the alert notifying a user that the data request is subject to adjustment by the data control module.

4. The system of claim 1, wherein the consumption analytics module outputs a traceability report to the interface.

5. The system of claim 1, wherein the consumption analytics module outputs a traceability report to the data control module, and wherein the data control module automatically generates a replenishment request using the traceability report and one or more threshold factors.

6. The system of claim 5, wherein the one or more threshold factors include at least one of a quantity threshold, a lift threshold, a reverse lift threshold, or a lead time threshold.

7. The system of claim 1, wherein the consumption analytics module further comprises:
a quantity regulation component that provides an indication to the data control module as to whether a quantity regulation factor is a threshold factor for adjustment of the attempted data request value.

8. The system of claim 7, wherein the quantity regulation component is configured as a Boolean field.

9. A method for context-specific forecasting implemented on at least one processor, comprising:
obtaining data related to consumption units and saleable units associated with an individual environment via a communication network coupled to the at least one processor;
computing an adjusted unit value of an individual consumption unit for a given time period associated with one or more of the saleable units of the individual environment;
indexing the computed adjusted unit value to generate a consumption unit value for the consumption unit related to at least one of the one or more saleable units; and
generating a forecasted consumption value of the consumption unit for the individual environment based on the generated consumption unit value and a composite consumption value associated with a region corresponding to the individual environment.

10. The method of claim 9, wherein computing the adjusted unit value further comprises:
identifying a total units sold value corresponding to the given time period for the saleable units associated with the individual environment;
determining whether at least a portion of the total units sold value is unrelated to the consumption unit;
responsive to determining that at least the portion of the total units sold value is unrelated to the consumption unit, generating an unrelated unit value; and
subtracting the unrelated unit value from the total units sold value to generate the adjusted unit value.

11. The method of claim 9, wherein computing the adjusted unit value further comprises:
identifying a total units sold value corresponding to the given time period for the saleable units associated with the individual environment;
determining whether at least a portion of the total units sold value has an adjusted relational value to the consumption unit;
responsive to determining that at least the portion of the total units sold value has an adjusted relational value to the consumption unit, generating an adjusted relational unit value; and
calculating the adjusted relational unit value and the total units sold value to generate the adjusted unit value.

12. The method of claim 9, wherein indexing the computed adjusted unit value to generate the consumption unit value for the consumption unit further comprises:
identifying a relative time period adjacent to the given time period for a given year and an aggregate adjusted unit value associated with the relative time period; determining a corresponding time period to the relative time period for another year and a corresponding aggregate adjusted unit value associated with the corresponding time period; and
calculating a year over year index value based on the aggregate adjusted unit value and the corresponding aggregate adjusted unit value, the year over year index value used to generate the consumption unit value.

13. The method of claim 12, wherein the year over year index value is at least one of a lift or a reverse lift.

14. The method of claim 9, wherein the consumption unit related to at least one of the one or more saleable units is at least one of a plastic bag, paper bag, reusable container, or disposable container.

15. The method of claim 9, further comprising:
determining whether the individual environment is allocated a threshold factor;
responsive to determining that the individual environment is allocated a threshold factor, identifying an allowed threshold value for the individual environment; and
calculating the identified allowed threshold value based on the generated forecasted consumption value to generate a maximum data value for the given time period and the consumption unit.

16. The method of claim 15, further comprising:
determining whether a quantity regulation factor is activated for the individual environment;
responsive to determining that the quantity regulation factor is activated, identifying a quantity deduction value associated with the individual environment; and
calculating the identified allowed threshold value based on the generated forecasted consumption value and the quantity deduction value to generate the maximum data value for the given time period and the consumption unit.

17. The method of claim 9, further comprising:
outputting a traceability report, including a consumption unit identifier, an individual environment identifier, a user identifier associated with a data request for the consumption unit for the individual environment, a data request date, the forecasted consumption value for the consumption unit for the given period of time based on the data request date, an attempted data request value, a quantity value for the consumption unit associated with the individual environment, and an allowed data request value for the consumption unit associated with the individual environment.

18. One or more computer storage devices having computer-executable instructions stored thereon for context-specific data control, which, on execution by a computer, cause the computer to perform operations comprising:
an interface component that receives a data request for a consumption unit, including an attempted data request value, the data request associated with an individual environment and corresponding to a given period of time;
a forecast component that identifies a forecasted consumption value for the consumption unit, the forecasted consumption value corresponding to the individual environment and the given period of time; and
a data control component that identifies a threshold factor for the consumption unit, the threshold factor corresponding to the individual environment and the given period of time, and generates an allowance threshold for the data request.

19. The one or more computer storage devices of claim 18, wherein the data control component further:
determines whether the attempted data request value is less than or equal to the allowance threshold;
responsive to determining the attempted data request value is less than or equal to the allowance threshold, processes the data request using the attempted data request value; and
responsive to determining that the attempted data request value exceeds the allowance threshold, adjusts the attempted data request value based on the allowance threshold to generate an adjusted data request value.

20. The one or more computer storage devices of claim 19, wherein the data control component further:
determines whether a quantity regulation factor is activated for the individual environment;
responsive to determining that the quantity regulation factor is activated, identifies a quantity deduction value associated with the individual environment; and
adjusts the attempted data request value based on the allowance threshold less the quantity deduction value to generate the adjusted data request value.
